(19) United States
(12) Patent Application Publication
(10) Pub. No.: US 2009/0046478 A1
(43) Pub. Date: Feb. 19, 2009

(54) BACKLIGHT MODULE AND OPTICAL FILM THEREOF

(76) Inventors: Horng-Jou Wang, Taoyuan Hsien (TW); Chi-Hung Kao, Taoyuan Hsien (TW); Huang-kun Chen, Taoyuan Hsien (TW)

Correspondence Address: BIRCH STEWART KOLASCH & BIRCH, PO BOX 747, FALLS CHURCH, VA, 22040-0747, US

(21) Appl. No.: 12/022,032

(22) Filed: Jan. 29, 2008

(30) Foreign Application Priority Data
Aug. 15, 2007 (TW) 096130162

(51) Int. Cl. F21V 7/04; G02B 5/04

(52) U.S. Cl. 362/611; 359/831; 362/619

(57) ABSTRACT

An optical film includes a substrate and at least one pyramid-like structure. The pyramid-like structure is disposed on one surface of the substrate and has a base, a first face, a second face and a third face. The first, second and third faces are connected together and disposed along the base.

### CROSS REFERENCE TO RELATED APPLICATIONS

This Non-provisional application claims priority under 35 U.S.C. §119(a) on Patent Application No(s). 096130162 filed in Taiwan, Republic of China on Aug. 15, 2007, the entire contents of which are hereby incorporated by reference.

### BACKGROUND OF THE INVENTION

1. Field of Invention

The invention relates to a backlight module and an optical film thereof that are capable of enhancing brightness in two axial directions.

2. Related Art

With the coming of the digital age, the technology of a flat panel display also grows rapidly and the flat panel display has become one of the indispensable electronic products. Thus, the requirements on the technology and the function of the flat panel display are also increased.

The flat panel display mainly includes a flat display panel and a backlight module. The flat display panel mainly has a color filtering substrate, a thin-film transistor (TFT) substrate and a liquid crystal layer interposed between the color filtering substrate and the TFT substrate. The backlight module serves as a backlight source for uniformly distributing the light, coming from a light source, over a surface of a liquid crystal panel. Conventionally, a cold cathode fluorescent lamp (CCFL) serves as the light source of the backlight module, and the backlight modules can be classified into direct type backlight modules and side-edge backlight modules according to the arrangement of the light source. Recently, in order to enhance the brightness visual effect of the flat panel display, the angle of emission of the light passing through a brightness enhancement film has to be decreased to the angle within ±30 or ±40 degrees. Therefore, enhancing the function of the brightness enhancement film of the backlight module has become one of the indispensable technologies of the backlight module.

Referring to FIG. 1, a conventional backlight module 1A includes a light source 11, at least one diffuser film 14 and a brightness enhancement film 12. If the backlight module 1A is a side-edge backlight module, the diffuser film 14 and the brightness enhancement film 12 are disposed on a light guide plate 13 in sequence. The light source 11 emits light L1 and is disposed on one side of the light guide plate 13. The light L1 is guided by the light guide plate 13 to pass through the diffuser film 14 and then enter the brightness enhancement film 12, as shown in FIG. 1. If a backlight module 1B is a direct type backlight module, the diffuser film 14 and the brightness enhancement film 12 are sequentially disposed on the light source 11. The light L1 of the light source 11 directly enters the diffuser film 14, and then enters the brightness enhancement film 12, as shown in FIG. 2.

The brightness enhancement film 12 can refract the incident light L1 into output light with small angles so that the angle of emission of most light L1 can be decreased to fall within ±30 or ±40 degrees and the observer within ±30 or ±40 degrees of the optical axis can have the stronger brightness visual effect. Referring again to FIG. 1, U.S. Pat. No. 6,091,547 discloses prism surface structures 121 of the brightness enhancement film 12, which are arranged in parallel along a single direction V1. In the above-mentioned method, however, only the brightness enhancing effect in the single-axis direction, such as the horizontal direction or the vertical direction, can be provided. So, if the brightness enhancing effects in the two axial directions (i.e., the brightness enhancing effects in the horizontal direction and the vertical direction) have to be achieved, two brightness enhancement films 12 have to be stacked together, and the prism surface structures 121 of the two brightness enhancement films 12 are arranged in parallel along a first direction V2 and a second direction V3 perpendicular to the first direction V2, as shown in FIG. 2.

However, using two brightness enhancement films 12 not only increases the cost but also decreases the transmission rate.

Therefore, it is necessary to provide a backlight module and an optical film thereof, in which brightness enhancing effects in two axial directions can be both reached, the cost can be reduced and the transmission rate can be enhanced.

### SUMMARY OF THE INVENTION

In view of the foregoing, the invention is to provide a backlight module and an optical film thereof, in which brightness enhancing effects in two axial directions can be both reached, the cost can be reduced and the transmission rate can be enhanced.

To achieve the above, the invention discloses an optical film including a substrate and at least one pyramid-like structure. The pyramid-like structure is disposed on a first surface of the substrate. The pyramid-like structure has a base, a first face, a second face and a third face. The first, second and third faces are connected together and disposed along the base. At least one of the first, second and third faces relative to the base forms an included angle smaller than 90 degrees.

In addition, the invention also discloses a backlight module including a light source and an optical film. The light source is for emitting light. The optical film is disposed on an optical path of the light and includes a substrate and at least one pyramid-like structure. The pyramid-like structure is disposed on a first surface of the substrate and has a base, a first face, a second face and a third face. The first, second and third faces are connected together and disposed along the base. At least one of the first, second and third faces relative to the base forms an included angle smaller than 90 degrees.

As mentioned above, the backlight module and the optical film thereof according to the invention have the following features. First, the optical film is disposed on the optical path of the light emitted from the light source, and is disposed on the base through each pyramid-like structure of the optical film. In addition, at least one of the first, second and third faces connected together in the pyramid-like structure forms an included angle smaller than 90 degrees relative to the base. Compared with the prior art, the invention only uses a single optical film, which has the pyramid-like structure disposed on the substrate. Accordingly, the cost can be decreased, and the first, second and third faces of the pyramid-like structure can cooperate with one another so that the brightness enhancement effects in the two axial directions can be achieved when the light passes through the pyramid-like structure. Furthermore, it is possible to prevent the transmission rate of the light from being decreased.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic illustration showing a conventional backlight module;

FIG. 2 is a schematic illustration showing another conventional backlight module;

FIG. 3 is a schematic illustration showing a backlight module according to a first embodiment of the invention;

FIG. 4 is a pictorial view showing the backlight module according to the first embodiment of the invention;

FIGS. 5A and 5B are pictorial views showing one of pyramid-like structures in FIG. 4;

FIGS. 6A to 6C are schematic top views showing different arrangement aspects of an optical film according to the first embodiment of the invention;

FIG. 7A is a cross-sectional view taken along a line A-A of FIG. 6A;

FIG. 7B is a cross-sectional view taken along a line B-B of FIG. 6B;

FIG. 8A is a cross-sectional view showing another optical film;

FIG. 8B is a cross-sectional view showing still another optical film;

FIGS. 9A and 9B are schematic illustrations respectively showing optical films of different aspects;

FIG. 10 is a graph showing relationships between optical axis angles and brightness of the optical film according to the first embodiment of the invention; and

FIG. 11 is a schematic illustration showing a backlight module according to the second embodiment of the invention.

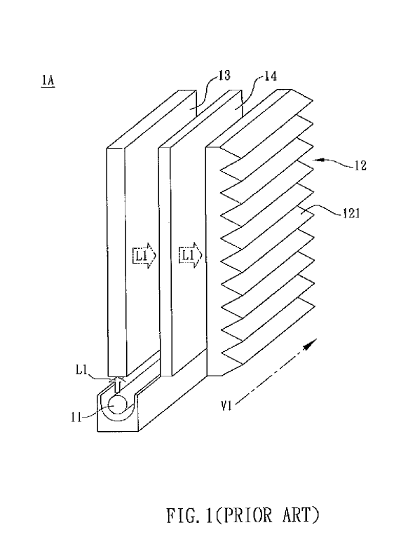

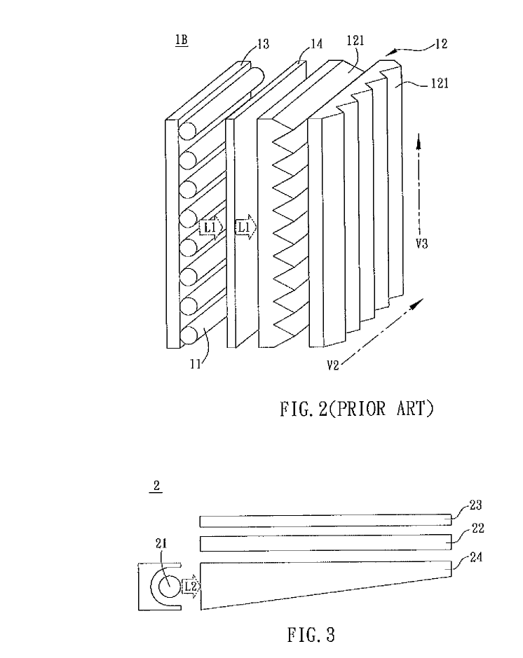

### DETAILED DESCRIPTION OF THE INVENTION

The present invention will be apparent from the following detailed description, which proceeds with reference to the accompanying drawings, wherein the same references relate to the same elements.

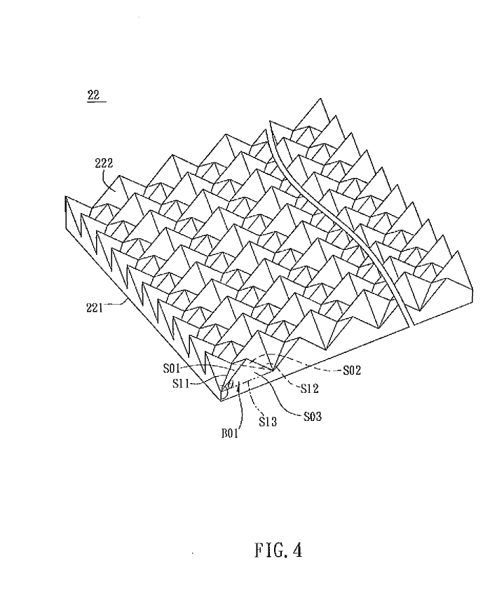

Referring to FIG. 3, a backlight module 2 according to a first embodiment of the invention includes a light source 21, an optical film 22, a first diffuser plate 23 and a light guide plate 24. In this embodiment, the backlight module 2 can be implemented as a direct type backlight module or a side-edge backlight module. In this example herein, the backlight module 2 is the side-edge backlight module.

In this embodiment, the first diffuser plate 23 is disposed on one side of the optical film 22, and the light guide plate 24 is disposed on the other side of the optical film 22. The light source 21 is disposed adjacent to the light guide plate 24, and the light source 21 emits light L2 to the light guide plate 24. The light L2 travels to the optical film 22 through the light guide plate 24.

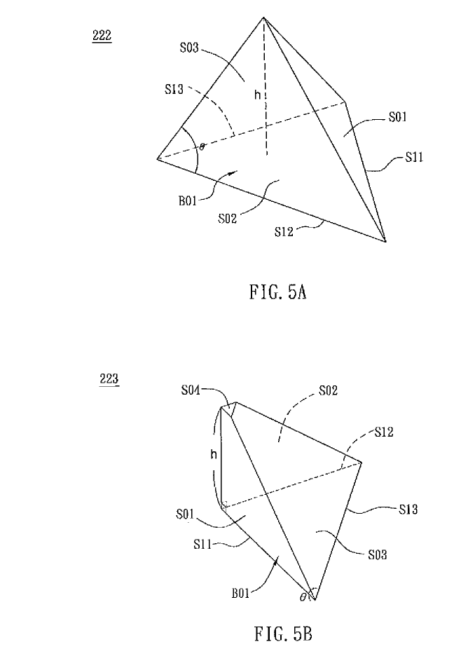

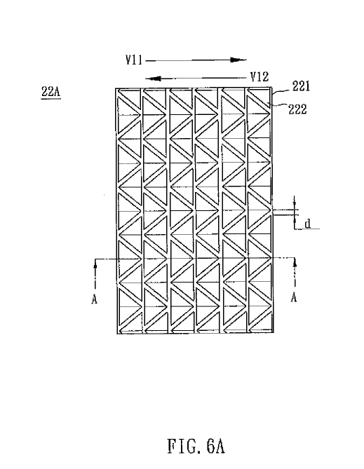

FIGS. 5A to 5B are pictorial views showing the optical film 22. With reference to FIGS. 4 to 5B, the optical film 22 has a substrate 221 and at least one pyramid-like structure 222. The material of the optical film 22 can be polyethylene terephthalate (PET), polycarbonate (PC) or polymethylmethacrylate (PMMA). Of course, the material of the optical film 22 can further be a transparent material.

Each pyramid-like structure 222 is disposed on one surface of the substrate 221 and has a base B01, a first face S01, a second face S02 and a third face 803. The base B01 has a first edge S11, a second edge S12 and a third edge S13 connected together, as shown in FIGS. 5A and 5B, and the first face S01, the second face S02 and the third face S03 are respectively disposed along the first edge S11, the second edge S12 and the third edge S13 of the base B01.

That is, the first face S01, the second face S02 and the third face S03 are respectively connected with the first edge S11, the second edge S12 and the third edge S13. At least one of the first face S01, the second face S02 and the third face S03 forms an included angle θ relative to the base B01, and the included angle α is smaller than 90 degrees. For example, each of the first face S01, the second face S02 and the third face S03 forms the included angle θ smaller than 90 degrees relative to the base B01, as shown in FIGS. 4 and 5A, or the third face S03 and the base B01 form the included angle θ smaller than 90 degrees while each of the first face S01 and the second face S02 forms the included angle θ of 90 degrees relative to the base B01, as shown in FIG. 5B.

In this embodiment, the shape of the base B01 can be implemented as a triangle, and the lengths of the first edge S11, the second edge S12 and the third edge S13 of the base B01 substantially are greater than 10 μm, and preferably range from 10 μm to 100 μm and are substantially the same in the example when the base B01 is a regular triangle. Alternatively, the first edge S11, the second edge S12 and the third edge S13 are substantially different from one another. Of course, two of the lengths of the first edge S11, the second edge S12 and the third edge S13 of the base B01 may be substantially the same in the example when the base B01 is an equilateral triangle. In addition, each of the first face S01, the second face S02 and the third face S03 of the pyramid-like structure 222 has a triangle-like shape, a right triangle shape or an equilateral triangle shape. The pyramid height h of the pyramid-like structure 222 is the same as or different from the lengths of the first edge S11, the second edge 812 and the third edge S13.

In addition, referring to FIG. 5B, a pyramid-like structure 223 of this embodiment further has a fourth face S04, which is disposed opposite to the base B01 and is connected with the first face Sot, the second face S02 and the third face S03. The fourth face S04 can be implemented as a flat surface, an inclined surface or a circular arc surface. In this example herein, the fourth face S04 is the flat surface and protects and prevents an element, such as a flat display panel (not shown), stacked about the optical film 22 from being scratched.

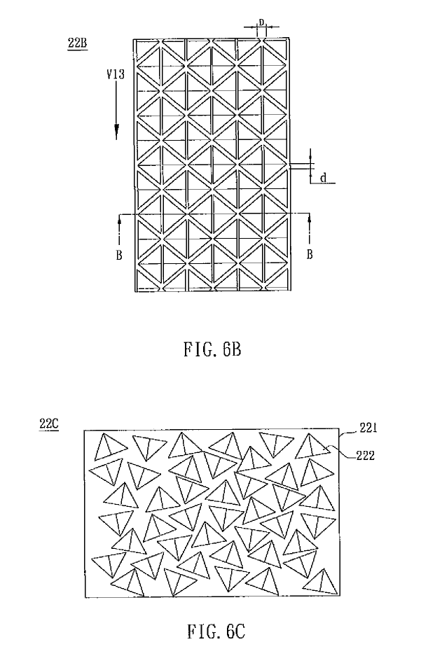

FIGS. 6A to 6C are schematic top views showing optical films 22A, 22B and 22C. The arrangement of the pyramid-like structures 222 is not particularly restricted. In practice, the pyramid-like structures 222 can be arranged regularly (see FIGS. 6A and 613) or irregularly or randomly (see FIG. 6C). There are many arrangements when the pyramid-like structures 222 are arranged regularly. In the first arrangement, the pyramid-like structures 222 of the optical film 22A can be arranged alternately along a first direction V11 and a second direction V12. In another arrangement, the pyramid-like structures 222 of the optical film 22B are arranged alternately along a third direction V13. Of course, the pyramid-like structures 222 can further be arranged separately with the interval distances d and D (see FIGS. 6A and 6B), and can also be arranged and connected together (not shown).

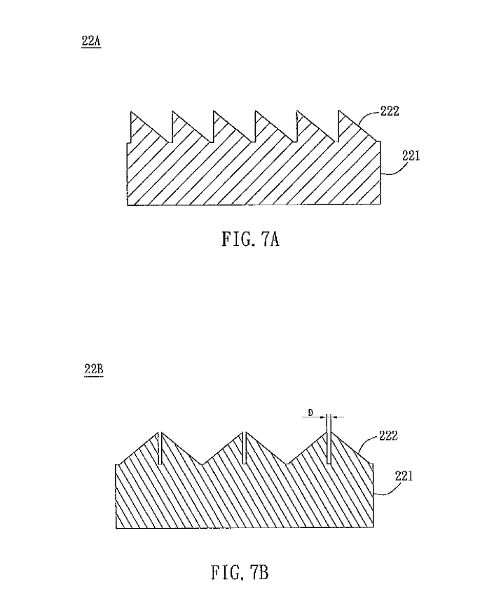

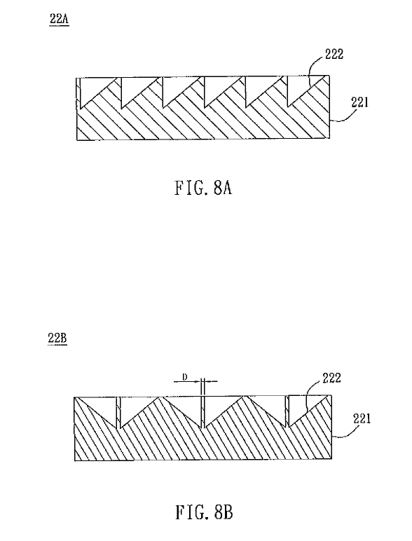

In addition, FIGS. 7A to 8B are cross-sectional views respectively showing the optical films 22A and 22B of FIGS. 6A and 61B, wherein the arrangement of each pyramid-like structure 222 is not particularly restricted. The pyramid-like structure 222 can protrude from the surface of the substrate 221, as shown in FIGS. 7A and 7B, or can be dented into the surface of the substrate 221, as shown in FIGS. 8A and 8B.

In practice, the substrate 221 and each pyramid-like structure 222 can be integrally formed or adhered together. Herein, the substrate 221 and each pyramid-like structure 222 are integrally formed as a single unit. In addition, the manufacturing method of the pyramid-like structure 222 is not particularly restricted. The pyramid-like structure 222 can be formed on the substrate 221 by soft pressing, hot pressing, hot rolling or ultra-violet ray solidification, or by photolithographic processing, electroforming, molding or precise micro-processing in the micro-electro-mechanical-system technology.

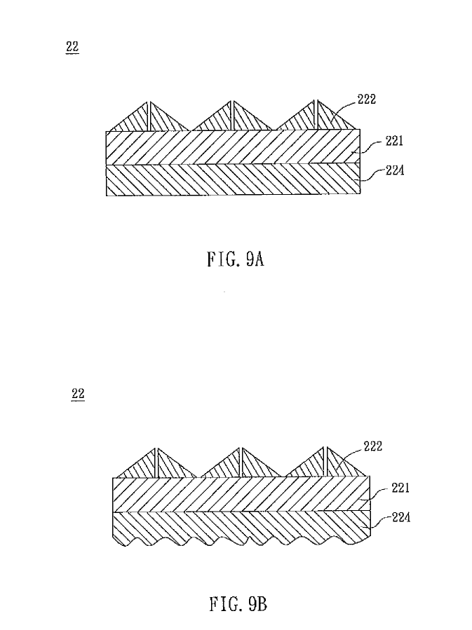

In addition, referring to FIGS. 9A and 9B, the optical film 22 further has an optical diffuser film 224, which is disposed opposite to the pyramid-like structure 222 and disposed on the other surface of the substrate 221. The material of the optical diffuser film 224 includes a mixture of transparent resin and particles, as shown in FIG. 9A. Of course, the material of the optical diffuser film 224 is a transparent material having a surface micro-structure, as shown in FIG. 9B. In this embodiment the surface of the substrate 221 on which the pyramid-like structure 222 is disposed is a light output surface, and the other surface of the substrate 221 opposite to the light output surface is a light input surface.

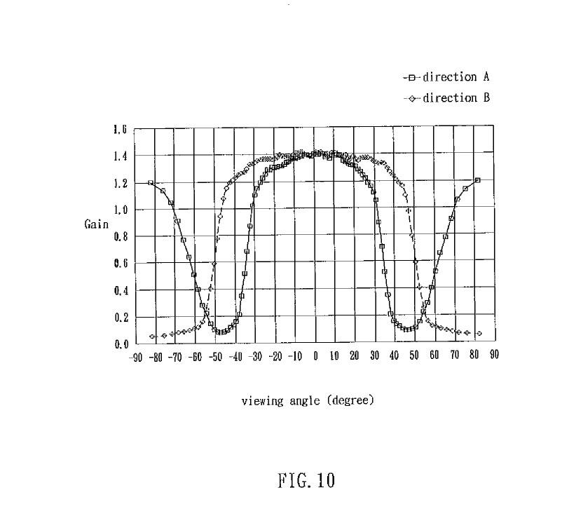

As shown in FIG. 10, when the light is incident to the optical film 22 and the pyramid-like structure 222, the light is refracted and then output with small angles. After the calculation of the simulation software, the relationships between the viewing angles and the brightness gains from the directions A and B are obtained. The result shows that the brightness gain thereof is greater than 1 when the viewing angle is within ±30 or +40 degrees. Thus, the brightness of the light can be greatly enhanced.

The backlight module 2 of this embodiment only needs one single optical film 22, and the first face S01, the second face S02 and the third face S03 of the pyramid-like structure 222 cooperate with one another so that when passing through the pyramid-like structure 222, the brightness enhancement effects of the light L2 in the vertical direction and the horizontal direction can be achieved and the cost can be reduced, and it is possible to prevent the light transmission rate from being decreased.

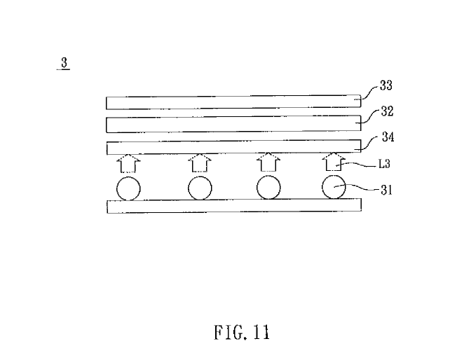

Referring to FIG. 11, a backlight module 3 according to a second embodiment of the invention includes a light source 31, an optical film 32 and a first diffuser plate 33. The structures and the effects of the light source 31, the optical film 32 and the first diffuser plate 33 are the same as those of the light source 21, the optical film 22 and the first diffuser plate 23 in the first embodiment (see FIG. 3), so detailed descriptions thereof will be omitted. The backlight module 3 of the second embodiment differs from the backlight module 2 of the first embodiment (FIG. 3) in that the backlight module 3 of the second embodiment further includes a second diffuser plate 34.

In addition, the first diffuser plate 33 is disposed on one side of the optical film 32, and the second diffuser plate 34 is disposed on the other side of the optical film 32. The light source emits light and is disposed opposite to the optical film and disposed on one side of the second diffuser plate 34. Herein, the backlight module 3 of this embodiment is a direct type backlight module.

In summary, the backlight module and the optical film thereof according to the invention have the following features. First, the optical film is disposed on the optical path of the light; emitted from the light source, and is disposed on the base through each pyramid-like structure of the optical film. In addition, at least one of the first, second and third faces connected together in the pyramid-like structure forms an included angle smaller than 90 degrees relative to the base. Compared with the prior art, the invention only uses a single optical film, which has the pyramid-like structure disposed on the substrate. Accordingly, the cost can be decreased, and the first, second and third faces of the pyramid-like structure can cooperate with one another so that the brightness enhancement effects in the two axial directions can be achieved when the light passes through the pyramid-like structure. Furthermore, it is possible to prevent the transmission rate of the light from being decreased.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An optical film comprising:
a substrate; and
at least one pyramid-like structure disposed on a surface of the substrate, wherein the pyramid-like structure has a base, a first face, a second face and a third face, and the first face, the second face and the third face are connected together and disposed along the base.

2. The optical film according to claim 1, wherein a shape of the base is a triangle or a regular triangle, and each of the first face, the second face and the third face has a triangle-like shape.

3. The optical film according to claim 1, wherein the base has a first edge, a second edge and a third edge connected with each other, and the first face, the second face and the third face are disposed along the first edge, the second edge and the third edge, respectively.

4. The optical film according to claim 3, wherein lengths of the first edge, the second edge and the third edge are the same or different, or lengths of two of the first edge, the second edge and the third edge are the same.

5. The optical film according to claim 3, wherein lengths of the first edge, the second edge and the third edge are greater than 10 μm.

6. The optical film according to claim 3, wherein lengths of the first edge, the second edge and the third edge substantially range from 10 μm to 100 μm.

7. The optical film according to claim 3, wherein a pyramid height of the pyramid-like structure is the same as or different from a length of the first edge, the second edge or the third edge.

8. The optical film according to claim 1, wherein the pyramid-like structures are arranged separately from each other by a distance, connected together or arranged alternately.

9. The optical film according to claim 1, wherein the pyramid-like structure further has a fourth face opposite to the base and connected to the first face, the second face and the third face.

10. The optical film according to claim 9, wherein the fourth face is a flat surface, an inclined surface or a circular arc surface.

11. The optical film according to claim 1, wherein the substrate and the pyramid-like structure are adhered together or integrally formed as a single unit.

12. The optical film according to claim 1, wherein a material of the optical film comprises polyethylene terephthalate (PET), polycarbonate (PC), polymethylmethacrylate (PMMA), or a transparent material.

13. The optical film according to claim 1, wherein the pyramid-like structure is formed by soft pressing, hot pressing, hot rolling or ultra-violet ray solidification, photolithographic processing, electroforming, molding or precise micro-processing.

14. The optical film according to claim 1, further comprising an optical diffuser film disposed on the other surface of the substrate, wherein the other surface of the substrate is a light input surface.

15. The optical film according to claim 17, wherein a material of the optical diffuser film comprises a mixture of a transparent resin and particles, or a transparent material.

16. The optical film according to claim 14, wherein the optical diffuser film has a surface micro-structure.

17. The optical film according to claim 1, wherein the pyramid-like structures are arranged regularly, irregularly or randomly.

18. The optical film according to claim 1, wherein at least one of the first face, the second face and the third face forms an included angle smaller than 90 degrees relative to the base, or at least two of the first face, the second face and the third face form included angles smaller than 90 degrees relative to the base.

19. The optical film according to claim 1, wherein a shape of one of the first face, the second face and third face is a right triangle or an equilateral triangle.

20. The optical film according to claim 1, wherein the pyramid-like structure is dented into or protruded from the substrate.

21. A backlight module comprising:
a light source for emitting light; and
an optical film disposed on an optical path of the light and comprising a substrate and at least one pyramid-like structure, wherein the pyramid-like structure is disposed on a surface of the substrate and has a base, a first face, a second face and a third face, and the first face, the second face and the third face are connected together and disposed along the base.

22. The backlight module according to claim 21, further comprising a first diffuser plate disposed on one side of the optical film.

23. The backlight module according to claim 22, further comprising a light guide plate disposed on the other side of the optical film opposite to the first diffuser plate, wherein the light guide plate is disposed on one side of the light source, and the light travels to the optical film through the light guide plate.

24. The backlight module according to claim 22, further comprising a second diffuser plate disposed opposite to the first diffuser plate and disposed on the other side of the optical film, wherein the light source is disposed on one side of the second diffuser plate and opposite to the optical film.
